(19) United States
(12) Patent Application Publication
(10) Pub. No.: US 2010/0103165 A1
(43) Pub. Date: Apr. 29, 2010

(54) IMAGE DECODING METHOD, IMAGE OUTPUTTING METHOD, AND IMAGE DECODING AND OUTPUTTING APPARATUSES

(75) Inventors: Dae-jong LEE, Suwon-si (KR); Hyun-kwon CHUNG, Seoul (KR); Kil-soo JUNG, Osan-si (KR); Sung-wook PARK, Seoul (KR)

Correspondence Address: North Star Intellectual Property Law, PC, P.O. Box 34688, Washington DC, DC, 20043, US

(73) Assignee: Samsung Electronics Co., Ltd., Suwon-si (KR)

(21) Appl. No.: 12/481,000

(22) Filed: Jun. 9, 2009

(30) Foreign Application Priority Data
Oct. 27, 2008 (KR) 10-2008-0105484

(51) Int. Cl. G06T 15/00; G09G 5/00

(52) U.S. Cl. 345/419; 345/629

(57) ABSTRACT

An image decoding method, an image outputting method, an image decoding apparatus and an outputting apparatus, the image outputting method including inputting an image; and if determined that the input image is a video image that is overlaid with a graphic image, outputting an area of the input image, which is overlaid with the graphic image, as a 2-dimensional (2-D) image and outputting the other area of the input image, which is not overlaid with the graphic image, as a 3-dimensional (3-D) image; and if determined that the input image is a video image that is not overlaid with a graphic image, outputting the input image as a 3-D image.

### CROSS-REFERENCE TO RELATED APPLICATION

This application claims the benefit of Korean Patent Application No. 10-2008-0105484, filed on Oct. 27, 2008, in the Korean Intellectual Property Office, the disclosure of which is incorporated herein in its entirety by reference.

### BACKGROUND OF THE INVENTION

1. Field of the Invention

An aspect of the present invention relates to an image decoding method, an image outputting method, and apparatuses for respectively performing the image decoding method and the image outputting method, and more particularly, to an image decoding method, an image outputting method, an image decoding apparatus and an image outputting apparatus for determining whether a video image is to be output as a 2-dimensional (2-D) image or a 3-dimensional (3-D) image according to whether the video image has been overlaid with a graphic image.

2. Description of the Related Art

Three-dimensional (3-D) image technology has become widely popular with the development of digital technology. The 3-D image technology gives depth information to a 2-dimensional (2-D) image in order to provide a more realistic image.

Since the left and right eyes of humans are horizontally separated by a predetermined distance, a 2-D image is seen differently by the left and right eyes, which is referred to as binocular disparity. The brain integrates these two different 2-D images in order to generate a perspective, realistic 3-D image.

The 3-D image technology is classified into two types of technologies; the first type is to generate video data as a 3-D image from the beginning, and the second type is to transform video data generated as a 2-D image into a 3-D image, and research on these two types of technologies has been conducted.

### SUMMARY OF THE INVENTION

An aspect of the present invention provides a technology for transforming video data generated as a 2-dimensional (2-D) image into a 3-dimensional (3-D) image. More particularly, an aspect of the invention provides an image decoding method, an image outputting method, an image decoding apparatus and an image outputting apparatus for outputting a predetermined area of a frame of a video image as a 2-D image and the other area of the frame, other than the predetermined area, as a 3-D image according to whether the video image has been overlaid with a graphic image.

According to an aspect of the present invention, there is provided an image outputting method including: inputting an image; if the input image is a video image that is overlaid with a graphic image, outputting an area of the input image, which is overlaid with the graphic image, as a 2-D (2-dimensional) image and the other area of the input image, which is not overlaid with the graphic image, as a 3-D (3-dimensional) image; and if the input image is a video image that is not overlaid with a graphic image, outputting the input image as a 3-D image.

According to an aspect of the present invention, the image outputting method may further include: receiving graphic image on-off information indicating whether the input mage is the video image that is overlaid with the graphic image; and determining whether the input image is the video image that is overlaid with the graphic image or the video image that is not overlaid with the graphic image, using the graphic image on-off information. The image outputting method may further include identifying a frame comprising an area, which is to be output as a 2-D image, from frames of the input image, using metadata, wherein the determination as to whether the input image is the video image that is overlaid with the graphic image or the video image that is not overlaid with the graphic image comprises determining whether an image of the frame comprising the area to be output as the 2-D image is the video image that is overlaid with the graphic image or the video image that is not overlaid with the graphic image.

According to another aspect of the present invention, the frame including the area to be output as the 2-D image may be identified using output time information of the frame that is extracted from the metadata. The image outputting method may further include identifying the area to be output as the 2-D image from the frame comprising the area to be output as the 2-D image, using the metadata.

According to another aspect of the present invention, the identification of the area to be output as the 2-D image may include extracting coordinate value information for identifying the area to be output as the 2-D image, from the metadata. The image outputting method may further include reading the metadata from a disk on which video data is recorded or downloading the metadata from a server through a communication network. The metadata may include identification information for identifying the video data, wherein the identification information comprises a disk identifier for identifying a disk on which the video data is recorded and a title identifier for identifying a title including the video data among titles recorded on the disk.

According to another aspect of the present invention, there is provided an image decoding method including: generating graphic image on-off information indicating whether an input image is a video image that is overlaid with a graphic image or a video image that is not overlaid with a graphic image; and transmitting the graphic image on-off information to an image outputting apparatus.

According to another aspect of the present invention, the generation of the graphic image on-off information may include generating the graphic image on-off information according to a command for the graphic image to be output or not to be output, wherein the command is input from a user. The image decoding method may further include: decoding video data to generate a video image; if a command is received from the user for the video image to be overlaid with the graphic image, decoding graphic data to generate the graphic image; and overlaying the video image with the graphic image and then transmitting the video image overlaid with the graphic image to an image outputting apparatus.

According to another aspect of the present invention, there is provided an image processing method including: decoding video data to generate a video image; if a command is received from a user for the video image to be overlaid with the graphic image, decoding graphic data to generate the graphic image; overlaying the video image with the graphic image; outputting an area of the video image overlaid with the graphic image as a 2-D image and the other area of the video image, not overlaid with the graphic image, as a 3-D image; and if a command is received from the user for the video image not to be overlaid with the graphic image, outputting the video image as a 3-D image.

According to another aspect of the present invention, there is provided an image outputting apparatus including: a 3-D image converter which, if an input image is a video image that is overlaid with a graphic image, converts another area of the input image, other than an area of the input image overlaid with the graphic image, into a 3-D image, and, if the input image is a video image that is not overlaid with a graphic image, transforms the input image into a 3-D image; and an outputting unit which, if the input image is the video image that is overlaid with the graphic image, outputs the area of the input image overlaid with the graphic image as a 2-D image and the another area of the input image, which is not overlaid with the graphic image, as a 3-D image, and, if the input image is the video image that is not overlaid with the graphic image, outputs the input image as a 3-D image.

According to another aspect of the present invention, there is provided an image decoding apparatus including: a graphic image on-off information generator which generates graphic image on-off information indicating whether an input image is a video image that is overlaid with a graphic image or a video image that is not overlaid with a graphic image and transmits the graphic image on-off information to an image outputting apparatus.

According to another aspect of the present invention, there is provided an image processing apparatus including: a video data decoder which decodes video data to generate a video image; a user interface which receives a command for the video image to be overlaid with a graphic image or not to be overlaid with the graphic image, from a user; a graphic data decoder which, if the command for the video image to be overlaid with the graphic image is received from the user through the user interface, decodes graphic data to generate the graphic image in response to the command; and a blender which overlays the video image with the graphic image; and an outputting unit which outputs an area of the video image overlaid with the graphic image as a 2-D image and the other area of the video image, which is not overlaid with the graphic image, as a 3-D image, and, if the command for the video image not to be overlaid with the graphic image is received from the user through the user interface, outputs the video image as a 3-D image in response to the command.

According to another aspect of the present invention, there is provided a computer-readable recording medium having embodied thereon a computer program for executing an image outputting method including: inputting an image; if the input image is a video image that is overlaid with a graphic image, outputting an area of the input image, which is overlaid with the graphic image, as a 2-D (2-dimensional) image and outputting the other area of the input image, other than the 2-D image, as a 3-D (3-dimensional) image; and if the input image is a video image that is not overlaid with a graphic image, outputting the input image as a 3-D image.

According to another aspect of the present invention, there is provided a computer-readable recording medium having embodied thereon a computer program for executing an image decoding method including: generating graphic image on-off information indicating whether an input image is a video image that is overlaid with a graphic image or a video image that is not overlaid with a graphic image; and transmitting the graphic image on-off information to an image outputting apparatus.

According to another aspect of the present invention, there is provided a computer-readable recording medium having embodied thereon a computer program for executing an image processing method including: decoding video data to generate a video image; if a command is received from a user for the video image to be overlaid with the graphic image, decoding graphic data to generate the graphic image; overlaying the video image with the graphic image; outputting an area of the video image overlaid with the graphic image as a 2-D image and the other area of the video image, which is not overlaid with the graphic image, as a 3-D image; and if a command is received from the user for the video image not to be overlaid with the graphic image, outputting the video image as a 3-D image.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates metadata on video data, according to an embodiment of the present invention;

FIG. 2 illustrates an image processing system for describing an image decoding method and an image outputting method, according to an embodiment of the present invention;

FIGS. 3A through 3C illustrate images that are generated by an image decoding apparatus of FIG. 2, according to embodiments of the present invention;

FIG. 4 is a block diagram of an image decoding apparatus according to an embodiment of the present invention;

FIG. 5 is a block diagram of an image outputting apparatus according to an embodiment of the present invention; and

FIG. 6 is a flowchart of an image outputting method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Exemplary embodiments of the present invention will now be described in detail with reference to the attached drawings.

An aspect of the present invention uses metadata on video data in order to transform the video data generated as a 2-dimensional (2-D) image into a 3-dimensional (3-D) image.

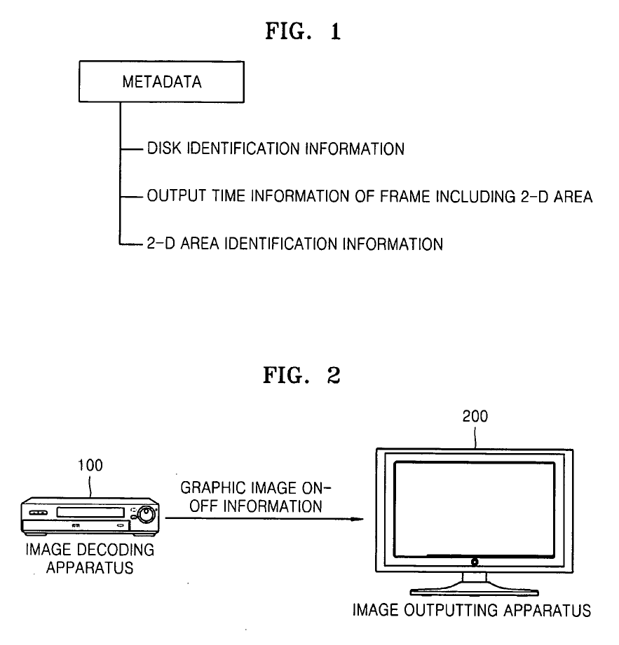

FIG. 1 illustrates metadata on video data, according to an embodiment of the present invention. The metadata of the present embodiment includes information for transforming video data of a 2-D image into a 3-D image. The metadata also includes disk identification information for identifying the video data in order to indicate what type of video data the metadata is on. The disk identification information may include a disk identifier for identifying a disk on which the video data is recorded and a title identifier for indicating a title including the video data among a plurality of titles recorded on the disk identified by the disk identifier.

Since the video data includes a sequence of frames, the metadata includes information regarding the frames.

The frames of the video data may include a frame that includes an image of a warning message, a menu screen, a caption, an ending credit, or the like so as not to be required to be output as a 3-D image. Also, a frame, which is to be output as a 3-D image, may include an area, such as an ending credit, and the like, as a part of the image, which is not required to be output as a 3-D image, and the other area, as another part of the image, that is required to be output as a 3-D image. Hereinafter, an area of a video image, which is to be output as a 2-D image without the necessity to be output as a 3-D image, is referred to as a 2-D area.

The metadata includes information regarding a 2-D area. An image outputting apparatus (not shown) extracts the information regarding the 2-D area from the metadata and outputs a predetermined area of a frame, such as an ending credit or the like, as a 2-D image, not a 3-D image, using the extracted information.

The information regarding the 2-D area includes output time information of the frame including the 2-D area and 2-D area identification information. The output time information of the frame including the 2-D area indicates a time that a frame of the frames including a 2-D area is to be output, i.e., a time that the frame including the 2-D area starts to be output. Alternatively, the output time information of the frame including the 2-D area may indicate period of time that the frame including the 2-D area is sequentially output and a time that outputting of the frame including the 2-D area ends.

The 2-D area identification information indicates an area of the frame including the 2-D area, which is to be 2-dimensionally output, i.e., the 2-D area, and may be expressed with coordinate values of the 2-D area based on a predetermined reference point of the frame.

Content providers, such as broadcasting stations or content producing companies, may generate metadata on video data and store the metadata in servers (not shown) in order to provide the metadata to users or may record the metadata on disks in order to provide the disks to the users. Metadata may be downloaded from a server or read from a disk along with video data or independent of the video data. If the metadata is recorded on the disk, the metadata may be recorded in one or more of a lead-in area, a user data area, and a lead-out area of the disk.

According to the present embodiment as described above, metadata includes information for transforming video data of a 2-D image into a 3-D image. The metadata also includes information for outputting a predetermined area of a frame as a 2-D area and the other area of the frame as a 3-D image.

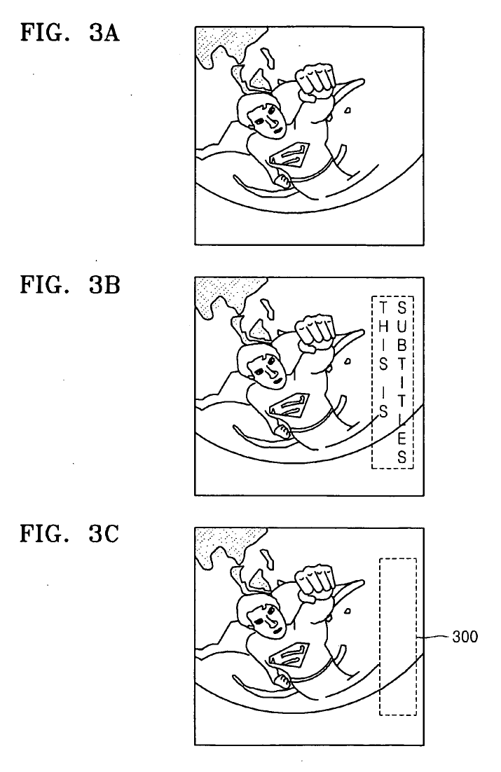

FIG. 2 illustrates an image processing system for describing an image decoding method and an image outputting method, according to an embodiment of the present invention. FIGS. 3A through 3C illustrate images that are generated by an image decoding apparatus 100 of FIG. 2, according to embodiments of the present invention.

Referring to FIG. 2, the image processing system includes the image decoding apparatus 100 and an image outputting apparatus 200. In the present embodiment shown in FIG. 2, the image decoding and outputting apparatuses 100 and 200 are separate from one another; however, the image decoding and outputting methods are not limited thereto and thus can be achieved using an apparatus into which the image decoding and outputting apparatuses 100 and 200 are integrated.

The image decoding apparatus 100 decodes video data to generate a 2-D video image and transmits the 2-D video image to the image outputting apparatus 200. Here, the image decoding apparatus 100 may be a digital versatile disk (DVD) player, a set-top box, or the like.

A user may control various functions of the image decoding apparatus 100 using a remote controller (not shown), and the like. The user may control the image decoding apparatus 100 to output a video image without a caption, i.e., subtitles or output the video image along with the subtitles.

If the user controls the image decoding apparatus 100 to output the video image along with the subtitles, the image decoding apparatus 100 decodes graphic data to generate a graphic image, overlays the video image with the graphic image, and transmits the video image overlaid with the graphic image to the image outputting apparatus 200.

FIGS. 3A and 3B illustrate the images that the image decoding apparatus 100 transmits to the image outputting apparatus 200. The image shown in FIG. 3A is a video image without subtitles. The image shown in FIG. 3B is a video image overlaid with a graphic image, i.e., subtitles.

The image outputting apparatus 200 transforms the 2-D video image generated by the image decoding apparatus 100 into a 3-D image and displays the 3-D image on a screen of the image outputting apparatus 200. Here, the image outputting apparatus 200 may be a monitor, a television (TV) screen, or the like.

The image outputting apparatus 200 transforms the 2-D video image received from the image decoding apparatus 100 into the 3-D image using the metadata as shown in FIG. 1. As described above, the metadata may be stored in a server (not shown) or may be recorded on a disk. If the metadata is stored in the server, the image outputting apparatus 200 may download the video data and/or the metadata on the video data from the server through a communication network and use the downloaded video data and/or metadata on the video data.

If the metadata includes information regarding a frame including a 2-D area, the image outputting apparatus 200 may identify a frame including a 2-D area from frames of the 2-D video image transmitted from the image decoding apparatus 100 and the 2-D area from the identified frame, using the metadata. An area 300 defined with a dotted line in FIG. 3C is a 2-D area (hereinafter the area 300 is referred to as a ‘2-D area 300). As previously described, the 2-D area refers to an area in which subtitles, a menu, or the like, are to be output and thus which is unnatural to be output as a 3-D image.

The image outputting apparatus 200 extracts information regarding the 2-D area 300, in which subtitles, a menu, or the like, are to be output, from the metadata, identifies the 2-D area 300 using the extracted information, outputs the 2-D area 300 as a 2-D image, and outputs the other area, other than the 2-D area 300, as a 3-D image.

If the user controls the image decoding apparatus 100 to output the video image without the subtitles, the image decoding apparatus 100 transmits the video image, which is not overlaid with the graphic image, as shown in FIG. 3C, to the image outputting apparatus 200. Since the image outputting apparatus 200 does not know about whether the video image transmitted from the image decoding apparatus 100 includes the graphic image, the image outputting apparatus 200 identifies an area in which subtitles are to be output, i.e., the 2-D area 300 defined with the dotted line in FIG. 3C, using the metadata, outputs the identified 2-D area 300 as a 2-D image, transforms the other area, other than the 2-D area 300, into a 3-D image, and outputs the 3-D image. Although the subtitles are not displayed on the 2-D area 300 of FIG. 3C, the image outputting apparatus 200 outputs the 2-D area 300 as the 2-D image, not a 3-D image. Thus, the 2-D area 300 is output as the 2-D image, and the other area of the frame is output as the 3-D image. As a result, the full image may be unnatural.

In the present embodiment, the image decoding apparatus 100 generates graphic image on-off information and transmits the graphic image on-off information to the image outputting apparatus 200 in order to inform the image outputting apparatus 200 whether the video image the image decoding apparatus 100 transmits includes the graphic image. The graphic image on-off information indicates whether the 2-D video image transmitted from the image decoding apparatus 100 to the image outputting apparatus 200 includes a graphic image such as subtitles, a menu, or the like.

If the user controls the image decoding apparatus 100 to output the video image along with the subtitles, the image decoding apparatus 100 transmits the video image overlaid with the graphic image as shown in FIG. 3B and the graphic image on-off information indicating that the video image is overlaid with the graphic image, to the image outputting apparatus 200. The image outputting apparatus 200 identifies the frame including the 2-D area and the 2-D area of the frame using the metadata, outputs the identified 2-D area as the 2-D image, and outputs the other area, other than the identified 2-D area, as the 3-D image. Since only a subtitles area of the full image output from the image outputting apparatus 200 is output as a 2-D image as described above, the user feels less visual fatigue or dizzy than when seeing a subtitles output as a 3-D image.

If the user controls the image decoding apparatus 100 to output only the video image without the subtitles, the image decoding apparatus 100 generates the video image, which is not overlaid with the graphic image, and graphic image on-off information indicating that the video image is not overlaid with the graphic image, and transmits the video image and the graphic image on-off information to the image outputting apparatus 200. In this case, the image outputting apparatus 200 transforms the 2-D area identified by the metadata into a 3-D image, not the 2-D image like the other area, and outputs the 3-D image. In the embodiment illustrated in FIG. 3C, the image outputting apparatus 200 outputs the 2-D area 300 and the other area as the 3-D images. Thus, heterogeneity and unnaturalness occurring when the 2-D area 300 and the other area coexist in a frame disappear.

If the image decoding and outputting apparatuses 100 and 200 support a High Definition Multimedia Interface (HDMI), the image decoding and outputting apparatuses 100 and 200 may transmit and receive the graphic image on-off information using the HDMI. The HDMI is one of non-compression digital video and/or audio interface standards and provides interfaces among apparatuses that support the HDMI. The HDMI has three communication channels, i.e., a transition minimized differential signaling (TMDS) channel, a display data channel (DDC), and a consumer electronics control (CEC) channel.

Transition Minimized Differential Signaling (TMDS) on HDMI carries video, audio, and auxiliary data via one of three modes called the Video Data Period, the Data Island Period, and the Control Period. During the Video Data Period, the pixels of and active video line are transmitted. During the Data Island period (which occurs during the horizontal and vertical blanking intervals), audio and auxiliary data are transmitted within a series of packets. The Control Period occurs between Video and Data Island periods.

Preamble data transmitted in the control period may include 4 bits in order to indicate whether a period occurring after the control period is the video data period (0b1000) or the Data Island period (0b1010). If the period occurring after the Control period is the Video Data period, a last bit of the preamble data may be expressed as “0” or “1” in order to indicate whether a video image is overlaid with a graphic image.

Transmission and reception of graphic image on-off information, which are performed by the image decoding and outputting apparatuses 100 and 200 using the CEC line, will now be described. The CEC line transmits control data which is used to perform controls among apparatuses that use the HDMI.

The control data transmitted through the CEC line may include information for indicating that transmitted data is control data on a graphic image, graphic image on-off information for indicating whether a video image is overlaid with a graphic image, and an address of the image outputting apparatus 200 that receives the control data.

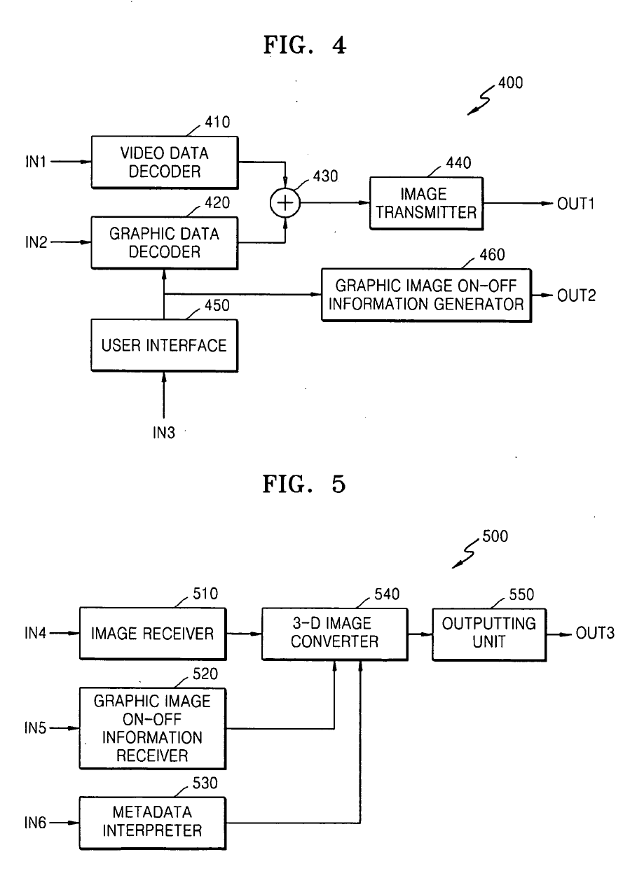

FIG. 4 is a block diagram of an image decoding apparatus 400 according to an embodiment of the present invention. Referring to FIG. 4, the image decoding apparatus 400 according to the present embodiment includes a video data decoder 410, a graphic data decoder 420, a blender 430, an image transmitter 440, a user interface 450, and a graphic image on-off information generator 460.

The video data decoder 410 reads video data IN1 from a local storage (not shown) or a loaded disk, and decodes the video data IN1 in order to generate a video image, wherein the video data IN1 is downloaded from a server (not shown) and then stored in the local storage or is recorded on the loaded disk.

The graphic data decoder 420 decodes presentation graphic data or interactive graphic data IN2 in order to generate a presentation or interactive graphic image indicating subtitles or an interactive graphic image indicating a menu.

The blender 430 overlays the video image generated by the video data decoder 410 with the presentation or interactive graphic image generated by the graphic data decoder 420 in order to generate a 2-D video image.

The image transmitter 440 transmits a video image, which is overlaid with a graphic image, or a video image, which is not overlaid with a graphic image, to the image outputting apparatus 200.

The user interface 450 takes charge of an interface with a user in order to receive a control command IN3 from the user and transmit the control command IN3 to the graphic data decoder 420 and the graphic image on-off information generator 460.

The graphic image on-off information generator 460 generates graphic image on-off information according to the control command IN3 which is input from the user through the user interface 450. The graphic image on-off information indicates whether the video image transmitted from the image transmitter 440 is overlaid with the graphic image.

Relations among the above elements of the image decoding apparatus 400 will now be described.

If the user inputs a command for a video image to be overlaid with a graphic image through the user interface 450, the graphic data decoder 420 decodes graphic data to generate a graphic image and transmits the graphic image to the image transmitter 440. The graphic image on-off information generator 460 generates graphic image on-off information indicating that the video image transmitted from the image transmitter 440 includes the graphic image.

If the user inputs a command for the video image not to be overlaid with the graphic image through the user interface 450, the graphic data decoder 420 does not decode the graphic data. In this case, a final 2-D image generated by the image transmitter 440 includes only the video image generated by the video data decoder 410. The graphic image on-off information generator 460 generates graphic image on-off information indicating that the video image transmitted from the image transmitter 440 does not include the graphic image.

The image transmitter 440 and the graphic image on-off information generator 460 simultaneously or separately transmit a video image OUT1 and graphic image on-off information OUT2 to the image outputting apparatus 200.

As described above, the image decoding apparatus 400 of the present embodiment generates graphic image on-off information indicating whether a video image is overlaid with a graphic image and transmits the graphic image on-off information to the image outputting apparatus 200.

FIG. 5 is a block diagram of an image outputting apparatus according to an embodiment of the present invention. Referring to FIG. 5, the image outputting apparatus 500 includes an image receiver 510, a graphic image on-off information receiver 520, a metadata interpreter 530, a 3-D image converter 540, and an outputting unit 550.

The image receiver 510 and the graphic image on-off information receiver 520 respectively receive a 2-D video image IN4 and graphic image on-off information IN5 from the image decoding apparatus 400.

The graphic image on-off information receiver 520 informs the 3-D image converter 540 of the graphic image on-off information IN5.

The metadata interpreter 530 reads metadata IN6 from a local storage (not shown) or a loaded disk and interprets the metadata IN6, wherein the metadata IN6 is downloaded from a server (not shown) and stored in the local storage through a communication network or is recorded on the loaded disk. The metadata interpreter 530 extracts information regarding a time that a frame including a 2-D area is to be output, from the metadata IN6 in order to identify the frame including the 2-D area and extracts 2-D area identification information from the metadata IN6 in order to identify an area, which is to be output as an 2-D image, i.e., the 2-D area, from the frame including the 2-D area. The metadata interpreter 530 informs the 3-D image converter 540 of the frame including the 2-D area and the 2-D area identified from the frame.

The 3-D image converter 540 converters the 2-D video image IN4, which is received from the image receiver 510, into a 3-D image using the graphic image on-off information IN5 received from the graphic image on-off information receiver 520 and the metadata IN6 received from the metadata interpreter 530.

The 3-D image converter 540 identifies the frame including the 2-D area and determines whether the identified frame is a video image that is overlaid with a graphic image or a video that is not overlaid with a graphic image. If the 3-D image converter 540 determines that the frame including the 2-D area is the video image that is overlaid with the graphic image, the 3-D image converter 540 transforms the other area of the frame, other than the 2-D area, into a 3-D image.

If the 3-D image converter 540 determines that the frame including the 2-D area is the video image that is not overlaid with the graphic image, the 3-D image converter 540 transforms the full frame including the 2-D area into a 3-D image.

Examples of a method of transforming a 2-D image into a 3-D image include two types of methods: the first method is to generate a depth map on a frame using a composition of the frame and give a sensation of depth to the frame using the depth map; and the second method is to estimate a motion of a current frame using a previous frame and output an image of the current frame as a 3-D image using the estimated motion.

The 3-D image converter 540 generates left and right eye images and a 3-D format image including the left and right eye images. Examples of a 3-D format include a top and down format, a side-by-side format, an interlaced format, and the like.

The outputting unit 550 sequentially outputs the left and right eye images OUT3 onto a screen. A viewer recognizes that an image is sequentially reproduced without being cut when the image is output at a minimum frame rate of 60 Hz based on one eye. Thus, the viewer combines images input from left and right eyes into a 3-D image on a screen, which is displayed at a minimum frame rate of 120 Hz by a display device. The outputting unit 550 sequentially displays the left and right images of a frame per 1/120 second.

In the present embodiment as described above, the image outputting apparatus 500 determines whether an area identified as a 2-D area using metadata is output as a 2-D image or as a 3-D image, depending on whether a video image is overlaid with a graphic image. The image outputting apparatus 500 outputs the 2-D area as the 2-D image or the 3-D image according to the determination result.

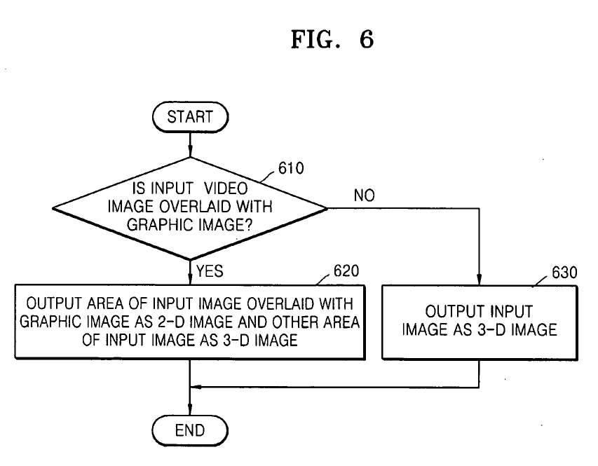

FIG. 6 is a flowchart of an image outputting method according to an embodiment of the present invention. Referring to FIG. 6, the image outputting apparatus 500 receives a video image and graphic image on-off information indicating whether the video image is overlaid with a graphic image, from the image decoding apparatus 400. In operation 610, the image outputting apparatus 500 identifies a frame including an area, which is to be output as a 2-D image, from frames of an input image using metadata and determines whether the frame including the 2-D area to be output as the 2-D image is a video image overlaid with a graphic image, using the graphic image on-off information. If it is determined in operation 610 that the frame is the video image that is overlaid with the graphic image, the image outputting apparatus 500 outputs an area of the frame overlaid with the graphic image as a 2-D image and the other area of the frame as a 3-D image in operation 620.

Otherwise, if it is determined in operation 610 that the frame is the video that is not overlaid with the graphic image, the image outputting apparatus 500 outputs the frame as a 3-D image in operation 630.

As described above, an image decoding method, an image outputting method, and image decoding and outputting apparatuses according to an aspect of the present invention can output a predetermined area of a frame of a video image as a 2-D image and the other area of the frame, other than the predetermined area, as a 3-D image depending on whether the video image is overlaid with a graphic image.

While this invention has been particularly shown and described with reference to particular embodiments thereof, it will be understood by those of ordinary skill in the art that various changes in form and details may be made therein without departing from the spirit and scope of the invention as defined by the appended claims. The embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An image outputting method comprising:
inputting an image;
if determined that the input image is a video image that is overlaid with a graphic image, outputting an area of the input image, which is overlaid with the graphic image, as a 2-D (2-dimensional) image and outputting an area of the input image, which is not overlaid with the graphic image, as a 3-D (3-dimensional) image; and
if determined that the input image is a video image that is not overlaid with a graphic image, outputting the input image as a 3-D image.

2. The image outputting method of claim 1, further comprising:
receiving graphic image on-off information indicating whether the input mage is the video image that is overlaid with the graphic image; and
determining whether the input image is the video image that is overlaid with the graphic image or the video image that is not overlaid with the graphic image, using the graphic image on-off information.

3. The image outputting method of claim 2, further comprising identifying a frame comprising an area, which is to be output as a 2-D image, from frames of the input image, using metadata,
wherein the determination as to whether the input image is the video image that is overlaid with the graphic image or the video image that is not overlaid with the graphic image comprises determining whether an image of the frame comprising the area to be output as the 2-D image is the video image that is overlaid with the graphic image or the video image that is not overlaid with the graphic image.

4. The image outputting method of claim 3, wherein the frame comprising the area to be output as the 2-D image is identified using output time information from the metadata.

5. The image outputting method of claim 3, further comprising identifying the area to be output as the 2-D image from the frame comprising the area to be output as the 2-D image, using the metadata.

6. The image outputting method of claim 5, wherein the identification of the area to be output as the 2-D image comprises extracting coordinate value information for identifying the area to be output as the 2-D image, from the metadata.

7. The image outputting method of claim 3, further comprising reading the metadata from a disk on which video data is recorded or downloading the metadata from a server through a communication network.

8. The image outputting method of claim 3, wherein the metadata comprises identification information for identifying video data, wherein the identification information comprises a disk identifier for identifying a disk on which the video data is recorded and a title identifier for identifying a title including the video data among titles recorded on the disk.

9. An image decoding method comprising:
generating graphic image on-off information indicating whether an input image is a video image that is overlaid with a graphic image or a video image that is not overlaid with the graphic image; and
transmitting the graphic image on-off information to an image outputting apparatus.

10. The image decoding method of claim 9, wherein the generation of the graphic image on-off information comprises generating the graphic image on-off information according to a command for the graphic image to be output or not to be output, wherein the command is input from a user.

11. The image decoding method of claim 9, wherein if a command is received from a user for the video image to be overlaid with the graphic image, decoding graphic data to generate the graphic image; and
overlaying the video image with the graphic image and then transmitting the video image overlaid with the graphic image to the image outputting apparatus.

12. An image processing method comprising:
decoding video data to generate a video image;
if a command is received from a user for the video image to be overlaid with a graphic image, decoding graphic data to generate the graphic image;
overlaying the video image with the graphic image;
outputting an area of the video image overlaid with the graphic image as a 2-D image and the other area of the video image, other than the area of the video image overlaid with the graphic image, as a 3-D image; and
if a command is received from the user for the video image not to be overlaid with the graphic image, outputting the video image as a 3-D image.

13. An image outputting apparatus comprising:
a 3-D image converter which, if an input image is a video image that is overlaid with a graphic image, converts another area of the input image, other than an area of the input image overlaid with the graphic image, into a 3-D image, and, if the input image is a video image that is not overlaid with a graphic image, transforms the input image into a 3-D image; and
an outputting unit which, if the input image is the video image that is overlaid with the graphic image, outputs the area of the input image overlaid with the graphic image as a 2-D image and the other area of the input image, other than the area of the input image overlaid with the graphic image, as a 3-D image, and, if the input image is the video image that is not overlaid with the graphic image, outputs the input image as a 3-D image.

14. The image outputting apparatus of claim 13, further comprising a graphic image on-off information receiver which receives graphic image on-off information indicating whether the input image is the video image overlaid with the graphic image,
wherein the 3-D image converter determines whether the input image is the video image that is overlaid with the graphic image or the video image that is not overlaid with the graphic image, using the graphic image on-off information.

15. The image outputting apparatus of claim 14, further comprising a metadata interpreter which interprets metadata in order to identify a frame comprising an area, which is to be output as a 2-D image, from frames of the input image,
wherein the 3-D image converter determines whether an image of the frame identified by the metadata interpreter is the video image overlaid with the graphic image.

16. The image outputting apparatus of claim 15, wherein the metadata interpreter extracts output time information of the frame comprising the area to be output as the 2-D image, from the metadata, and identifies the frame comprising the area to be output as the 2-D image, using the output time information.

17. The image outputting apparatus of claim 15, wherein the metadata interpreter identifies the area to be output as the 2-D image from the frame comprising the area to be output as the 2-D image, using the metadata.

18. The image outputting apparatus of claim 17, wherein the metadata interpreter extracts coordinate value information for identifying the area to be output as the 2-D image, from the metadata.

19. The image outputting apparatus of claim 15, wherein the metadata interpreter reads the metadata from a disk on which video data is recorded or downloads the metadata from a server through a communication network.

20. The image outputting apparatus of claim 15, wherein the metadata comprises identification information for identifying video data, wherein the identification information comprises a disk identifier for identifying a disk on which the video data is recorded and a title identifier for identifying a title including the video data among titles recorded on the disk.

21. An image decoding apparatus comprising:
a graphic image on-off information generator which generates graphic image on-off information indicating whether an input image is a video image that is overlaid with a graphic image or a video image that is not overlaid with the graphic image and transmits the graphic image on-off information to an image outputting apparatus.

22. The image decoding apparatus of claim 21, wherein the graphic image on-off information generator generates the graphic image on-off information in response to a command for the graphic image to be output or not to be output, wherein the command is input from a user.

23. The image decoding apparatus of claim 21, further comprising:
a video data decoder which decodes video data to generate the video image;
a user interface which receives the command for the video image to be overlaid with the graphic image or not to be overlaid with the graphic image, from the user;
a graphic data decoder which decodes graphic data to generate the graphic image;
a blender which overlays the video image with the graphic image; and
an image transmitter which transmits the video image overlaid with the graphic image to an image outputting apparatus,
wherein if the graphic data decoder receives the command for the video image to be overlaid with the graphic image through the user interface, the graphic data decoder generates the graphic image in response to the command.

24. An image processing apparatus comprising:
a video data decoder which decodes video data to generate video image;
a user interface which receives a command for the video image to be overlaid with a graphic image or not to be overlaid with the graphic image, from a user;
a graphic data decoder which, if the command for the video image to be overlaid with the graphic image is received from the user through the user interface, decodes graphic data to generate the graphic image in response to the command; and
a blender which overlays the video image with the graphic image; and
an outputting unit which outputs an area of the video image overlaid with the graphic image as a 2-D image and outputs an area of the video image, other than the area overlaid with the graphic image, as a 3-D image, and, if the command for the video image not to be overlaid with the graphic image is received from the user through the user interface, outputs the video image as a 3-D image in response to the command.

25. A computer-readable recording medium having embodied thereon a computer program for executing the image outputting method of claim 1.

26. A computer-readable recording medium having embodied thereon a computer program for executing the image decoding method of claim 9.

27. A computer-readable recording medium having embodied thereon a computer program for executing the image processing method of claim 12.

28. The image outputting method of claim 3, wherein the metadata includes information for transforming the 2-D image into 3-D image.

29. The image outputting method of claim 8, wherein the video data includes a sequence of frames and the metadata includes information regarding the frames.

30. The image outputting method of claim 29, wherein the frames of the video data include a frame having an image of a warning message, a menu screen, a caption, or an ending credit, not required to be output as a 3-D image.
